(19) United States
(12) Patent Application Publication
(10) Pub. No.: US 2014/0153410 A1
(43) Pub. Date: Jun. 5, 2014

(54) MOBILE-TO-MOBILE RADIO ACCESS NETWORK EDGE OPTIMIZER MODULE CONTENT CROSS-CALL PARALLELIZED CONTENT RE-COMPRESSION, OPTIMIZATION, TRANSFER, AND SCHEDULING

(71) Applicant: NOKIA SIEMENS NETWORKS OY, Espoo (FI)

(72) Inventor: John Harris, Glenview, IL (US)

(73) Assignee: NOKIA SIEMENS NETWORKS OY, Espoo (FI)

(21) Appl. No.: 13/690,139

(22) Filed: Nov. 30, 2012

(51) Int. Cl. H04W 4/00

(52) U.S. Cl. CPC H04W 4/00
USPC 370/252; 370/328; 370/329

(57) ABSTRACT

Various communication systems may benefit from mobile-to-mobile management of cross-call content, including optimization, transfer and scheduling of the same. For example, in a mobile-to-mobile call, a first user's uplink media may be re-compressed while waiting for the media to return from a call server or a first user's uplink media may trigger an eNB/RAN element to prepare a second user RRC/grant just-in-time deliver media to the second user, upon a response from the call server. A method may comprise receiving audio/video on the uplink from a first mobile. The audio/video/media content may be extracted when it is received on the uplink from the first mobile, and may then be re-compressed/customized for delivery on the downlink to the second mobile. When the original content is received back from the server for delivery to the second mobile, the already re-compressed/customized version of the content may be transmitted down to the second mobile.

### BACKGROUND

1. Field

Various communication systems may benefit from mobile-to-mobile management of cross-call content, including optimization, transfer and scheduling of the same. For example, in a mobile-to-mobile call, a first user's uplink media may be re-compressed while waiting for the media to return from a call server or a first user's uplink media may trigger an evolved Node B/Radio Access Network Edge Optimizer Module (eNB/RAN element) to prepare a second user Radio Resource Control (RRC)/grant just-in-time delivery of media to the second user, upon a response from the call server. Further, as another example, the first user's uplink media may transmit down to the second user prior to the call server response.

2. Description of the Related Art

With the development of media compression and wireless network technologies, stream media technologies have been more and more widely used. Although bandwidth in wireless networks are increasing, unlike a fixed network, inherent factors in wireless networks, such as a packet loss rate, jitter, and time delay, may have an influence upon user's application experience. Further, a very large fraction of telephony calls are between two different parties which are very near one another, such that a significant fraction of the telephony is between two different parties under the same evolved Node B (eNB). A large fraction of telephony calls comprise calls between two different User Equipment (UE) under the same Communications Service Provider (CSP)/operator, for example, Verizon™, AT&T™ or Sprint™.

In addition, a major Quality of Experience (QoE) challenge for telephony may be the degradation resulting from longer one-way audio delay. This degradation may include the problem of buffer under runs, for example, when an audio packet is sufficiently late so that it does not arrive in time for playout at the listener UE.

Another QoE challenge is that with Over-the-Top (OTT) voice/telephony a significant source of audio jitter may be the delay encountered through the core network and up through the Internet. This may be experienced, for example, in OTT voice solutions.

A further QoE challenge may exist when two different parties start speaking and continue speaking for a long period of time before they realize that the other party is also speaking

Another challenge may be that re-optimizing content prior to downlink transmission can be processing intensive, especially if the optimizations must be performed on a strict delay budget. Further, re-optimizing content prior to downlink transmission can result in bearer paths delays as well.

### SUMMARY

According to a first embodiment, a method may comprise extracting an audio/video/media content when received on an uplink from a first user equipment. The method may include triggering local processing for delivery of the audio/video/media content on a downlink to a second user equipment. Further, the local processing for delivery of the audio/video/media content on the downlink to the second user equipment is performed during an original audio/video/media content round trip to and from a server.

According to a second embodiment, an apparatus may comprise at least one processor and at least one memory including computer program code. Further, the at least one memory and the computer program code are configured to, with the at least one processor, cause the apparatus at least to extract an audio/video/media content when received on an uplink from a first user equipment and to trigger local processing for delivery of the audio/video/media content on a downlink to a second user equipment. In addition, the local processing for delivery of the audio/video/media content on the downlink to the second user equipment is performed during an original audio/video/media content round trip to and from a server.

According to a third embodiment, an apparatus may comprise extracting means for extracting an audio/video/media content when received on an uplink from a first user equipment and triggering means for triggering local processing for delivery of the audio/video/media content on a downlink to a second user equipment. Further, the local processing for delivery of the audio/video/media content on the downlink to the second user equipment is performed during an original audio/video/media content round trip to and from a server.

According to a fourth embodiment, a non-transitory computer readable medium may be encoded with instruction that, when executed in hardware, perform a process, the process comprising the method according to the first embodiment.

### BRIEF DESCRIPTION OF THE DRAWINGS

For proper understanding of the invention, reference should be made to the accompanying drawings, wherein:

FIG. 1 illustrates a re-optimization method.

FIG. 2 illustrates a method according to certain embodiments.

FIG. 3 illustrates a scheduling method for downlink grant.

FIG. 4 illustrates another method according to certain embodiments.

FIG. 5 illustrates a transfer method.

FIG. 6 illustrates yet another method according to certain embodiments.

FIG. 7 illustrates yet another method according to certain embodiments.

FIG. 8 illustrates a system according to certain embodiments.

FIG. 9 illustrates a flowchart of a method according to certain embodiments.

FIG. 10 illustrates a continuation of the flowchart of a method according to certain embodiments.

### DETAILED DESCRIPTION

Certain embodiments may include a mobile-to-mobile, for example, UE-A to UE-B call, eNB/RAN element/LiquidApp™/LiquidNet™—application midpoint in which UE-A's uplink of media (audio/video) content may be re-compressed while waiting for the media to return from a call server. This technique may avoid critical path delay due to wireless aware re-compression/optimization. The technique may also enable leveraging Internet offload Gateway (IoG)/cloud/off-site Mobile Internet Protocols (MIPs) resources for re-compression. Further, the technique may match media content with the server response prior to transmission of the optimized media content to UE-B.

Certain embodiments may include UE-A's uplink of media (audio/video) triggering a Radio Access Network Edge Optimizer Module (RAN element) to prepare UE-B Radio Resource Control (RRC)/grant just-in-time delivery of media to UE-B, upon response from server. The RAN element, for example, may include or be an eNB or other network element capable of performing an edge optimization. The technique may cause latency reduction, for example, reduction of latency associated with UE Discontinuous Reception (DRX).

Certain embodiments may include UE-A's uplink of media (audio/video) that may be transmitted down to UE-B prior to a call server response. This technique may cause latency reduction via an Evolved Packet Core (EPC)-Server path. Further, the technique may mitigate sporadic jitter and provide a consistent delay reduction with smooth transition into and out of this reduction mode. Moreover, this technique may minimize audio overlap in passive interruption telephony scenarios.

In the case where two user equipment, say UE-A and UE-B for example, are engaged in a call under a single eNB, an eNB/Radio Access Network Edge Optimizer Module (RAN element) has the opportunity to impact the contents of individual packets passing through eNB/RAN element.

In the context of a UE-A to UE-B call under a single eNB, the eNB/RAN element may have the opportunity to accelerate delivery/optimization of mobile-to-mobile audio/video/media from an application level midpoint (for example, LiquidApp™/LiquidNet™), through at least three specific embodiments.

According to a first embodiment, a method may comprise receiving audio/video on the uplink from a first mobile. The RAN element may then be able to provide wireless aware re-compression/optimization of voice/video, without additional re-compression delays/strict delay requirement. The audio/video/media content may be extracted when it is received on the uplink from the first mobile device, and may then be re-compressed/customized for delivery on the downlink to the second mobile. As discussed herein, “audio/video/media content” can broadly encompass audio content, video content, or other media content. There is no requirement that both audio and video content be simultaneously present, for example. When the original content is received back from the server for delivery to the second mobile, at that point the already re-compressed/customized version of the content may be transmitted down to the second mobile device. In this example, mobile devices are used as examples of user equipment, but there is no requirement that the devices be mobile or capable of mobility.

According to a second embodiment, a method may comprise receiving audio/video on the uplink from a first mobile. The Radio Access Network Edge Optimizer Module (RAN element) can then trigger scheduling of downlink grant, or other Long Term Evolution (LTE) air interface signaling to second user to prepare for delivery of content received from a first user. This can further reduce latency, such as latency associated with UE DRX.

According to a third embodiment, a method may comprise receiving audio/video on the uplink from a first mobile. The RAN element can use this audio/video to replace the older content being received from the server for transmission to the second mobile on the downlink. This approach may bypass delay up through the Evolved Packet Core (EPC) onto the general Internet, or other public network, and back. This may, for example, mitigate sporadic jitter through the EPC-Server path. This approach also may provide an ongoing audio/video delay reduction with smooth transition into/out of this reduction mode. This approach further may minimize audio overlap in telephony interruption scenarios.

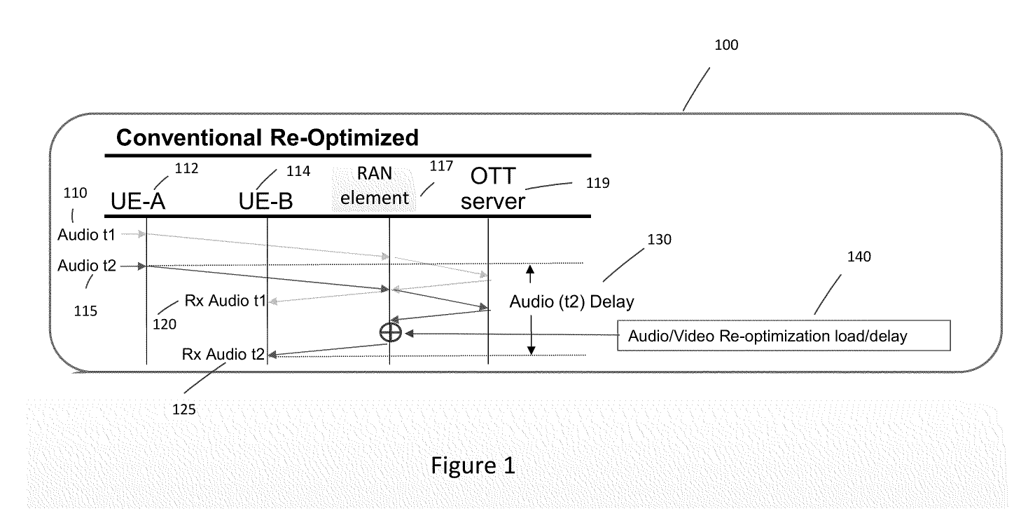

FIG. 1 illustrates a re-optimization method 100. Media content 110, 115 may be uplinked from a first user equipment (UE-A) 112 to an eNB/RAN element 117 and then to an OTT server 119. Next, the uplinked media 110, 115 may be downlinked to a second user equipment (UE-B) 114 as received media 120, 125, respectively. However, during the downlink an audio/video re-optimization load/delay 140 may be created at the eNB/RAN element 117, thereby causing a significant overall audio (media) delay 130. Normally there is a delay at 130 either on the downlink or optionally on the uplink (not shown) creating the delay 130 either going to OTT server 119 or when returning from OTT server 119.

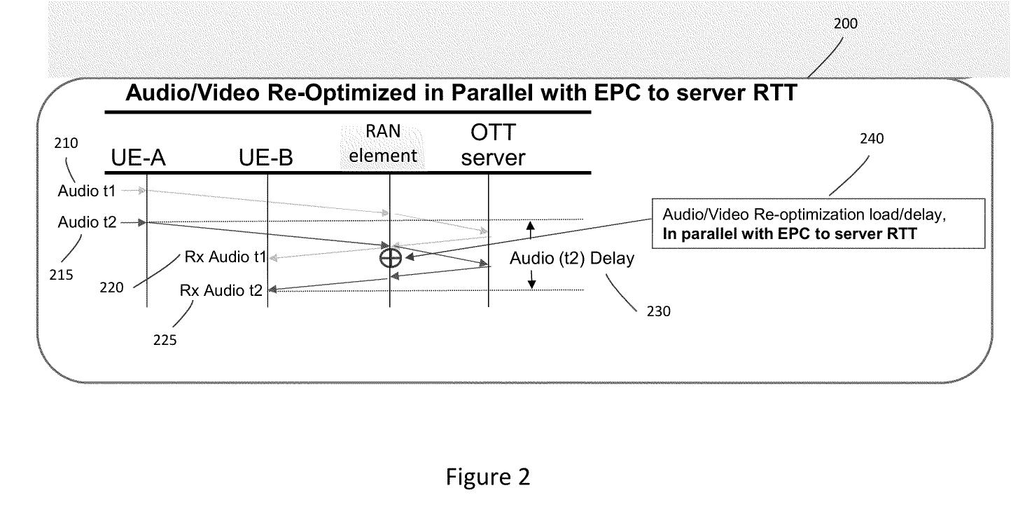

FIG. 2 illustrates a re-optimization method 200 according to certain embodiments. Media content 210, 215 are uplinked from UE-A 112 to eNB/RAN element 117 and then to OTT server 119. Next, the uplinked media 210, 215 is downlinked to UE-B 114 as received media 220, 225, respectively. In some embodiments, a re-optimization 240 may be performed in parallel with server response time so no additional delay is created by this re-optimization step. Thus, FIG. 2 shows audio/video re-optimization load/delay 240 being performed in parallel with Evolved Packet Core (EPC) to server Round Trip Time (RTT) resulting in a minimized audio (media) delay 230.

For example, media 210 may have no content and is therefore silent while media 215 contains content which is uplinked all the way up to OTT server 119. By way of example of media 215 may be Japanese and re-optimization may require translating Japanese into English at media 225. Thus, delay 230 is created for media 215 from UE-A 112 going to UE-B 114.

In some embodiments media 215 is sent immediately on the uplink to OTT server 119 but in parallel a re-optimization, such as translating Japanese into English, may occur via eNB/RAN element 117. In such an example, the media content 215 containing Japanese is received back from OTT server 119 at eNB/RAN element 117 where content 215 is monitored to confirm it is the same as content 225. If the content 215 matches that of content 225, then the uplink and downlink content is confirmed as being the same. As a further check, the re-optimized translation of content 215 may be available to send immediately to UE-B 114 upon confirmation. Thus, through parallelization the delay is reduced during transmission of content. This technique presents the advantage of zero risk because of the confirmation and checking aspect from OTT server 119.

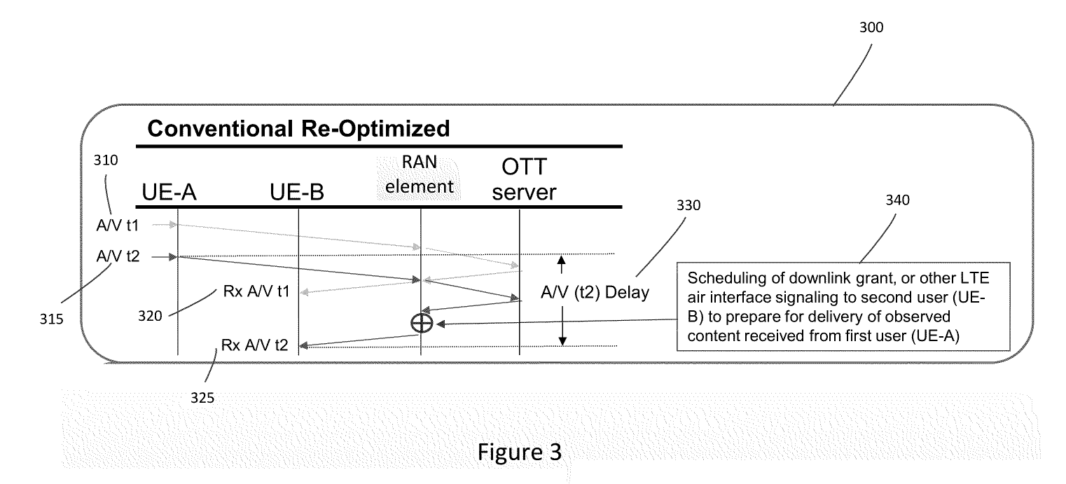

FIG. 3 illustrates a method 300 for scheduling downlink grant. Media content 310, 315 are uplinked as discussed above. Next, scheduling of downlink grant 340, or other Long Term Evolution (LTE) air interface signaling to UE-B 114 to prepare for delivery of observed content received from UE-A 112 can create an audio/video delay (t2) 330 when downlinked content media 320, 325 is received from OTT server 119, respectively. An example of downlink grant 340 may be control signaling which literally sends a grant/declaration to a user indicating that some content of a particular size at some set time in the future will be sent. Downlink grant 340 needs to be sent prior to sending the content from OTT server 119. This process may cause a delay 330 normally. Downlink grant 340 is triggered in response to seeing uplinked content 310, 315.

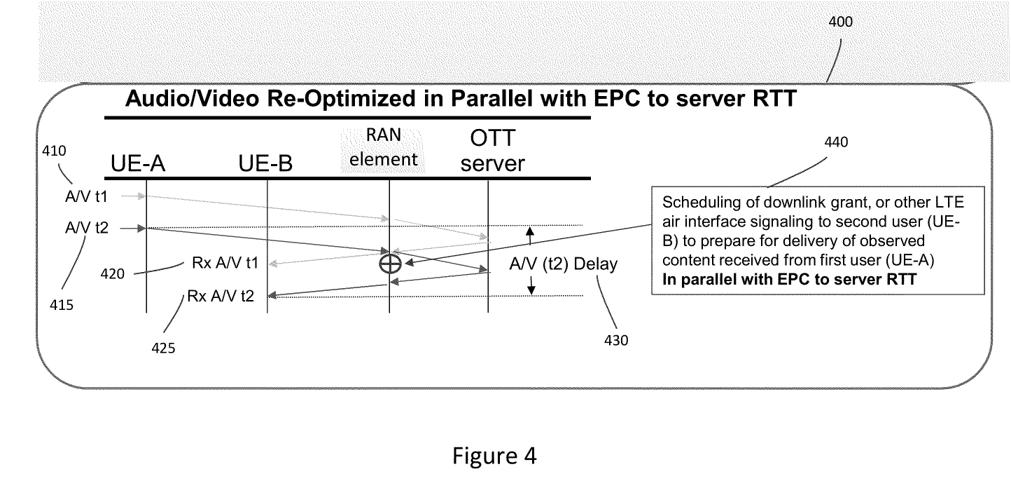

FIG. 4 illustrates a scheduling of downlink grant method 400 according to certain embodiments. Media content 410, 415 may be uplinked as discussed above. Next, scheduling of downlink grant 440, or other LTE air interface signaling to UE-B 114 to prepare for delivery of content received from first user UE-A 112 may be performed in parallel with waiting for EPC to server RTT to avoid an audio/video delay (t2) 430 when downlinked content 420, 425 is received, respectively. FIG. 4 illustrates that re-optimization may be performed in parallel with server response time. Thus, additional delay due to re-optimization may be avoided, resulting in a minimized audio/video (A/V) delay 430.

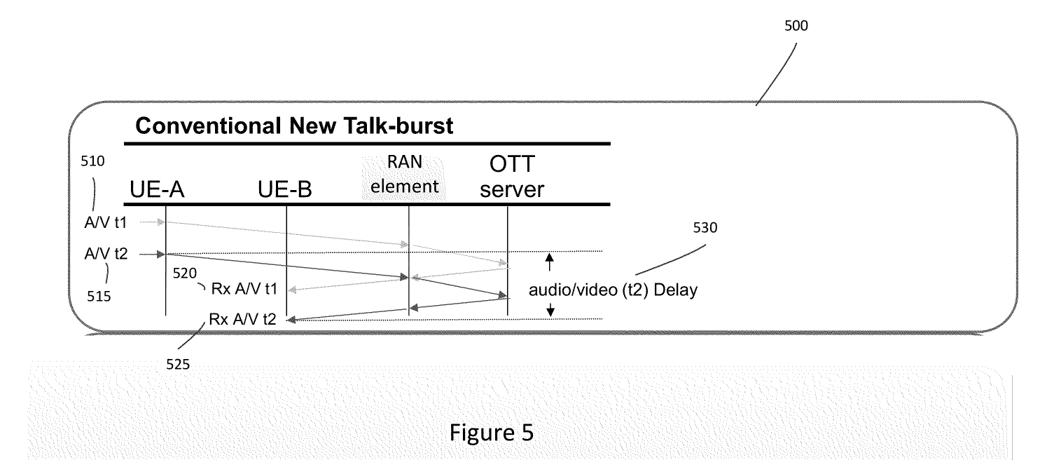

FIG. 5 illustrates a transfer method 500. In method 500, content 510, 515 may be uplinked as discussed above and a significant audio/video delay (t2) 530 may occur at OTT server 119 resulting in a delay for UE-B 114 receiving downlinked media content 520, 525.

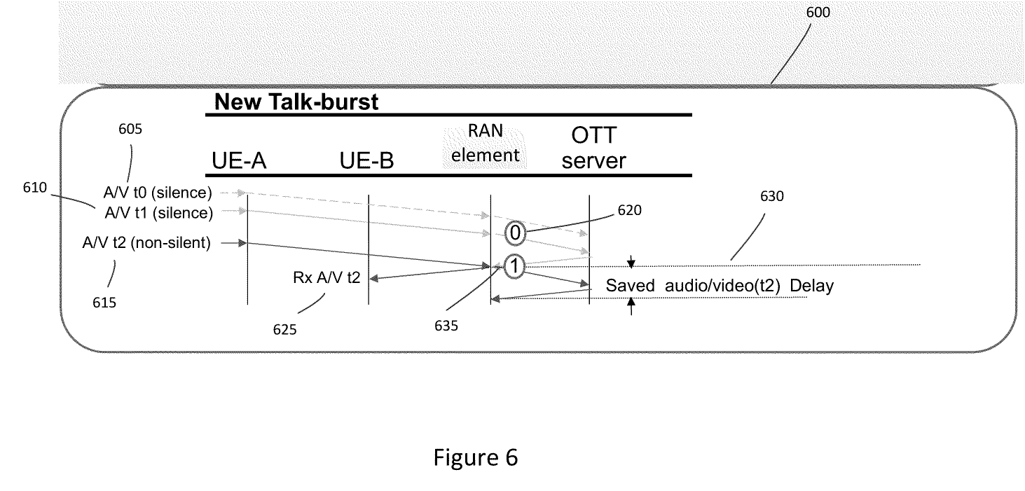

FIG. 6 illustrates a transfer method 600 according to certain embodiments. At 635, the eNB/RAN element 117 may determine that UE-A 112 has newly started talking. For example, at 620 the audio/video t1 610 normally to be transmitted on downlink to UE-B 114, may be silence. Moreover, the audio/video stream may have been silence for some time interval greater than a threshold. However, the audio/video t2 615 being received on the uplink is not silence. The eNB/RAN element 117 may also detect that UE-A 112 and UE-B 114 have both newly started talking This may be due, for example, to an interruption event.

Therefore, the eNB/RAN element 117 may begin copying at 635 the uplink audio/video t2 615 from UE-A 112 destined for OTT server 119 into the audio/video payload from OTT server 119 for delivery to UE-B 114. The eNB/RAN element 117 may continuously monitor and verify that UE-A 112 and UE-B 114 are in fact communicating with one another. Any of a number of techniques may be used to verify that audio/video received from OTT server 119 matches the audio/video content 605, 610, 615 that was transmitted up to OTT server 119.

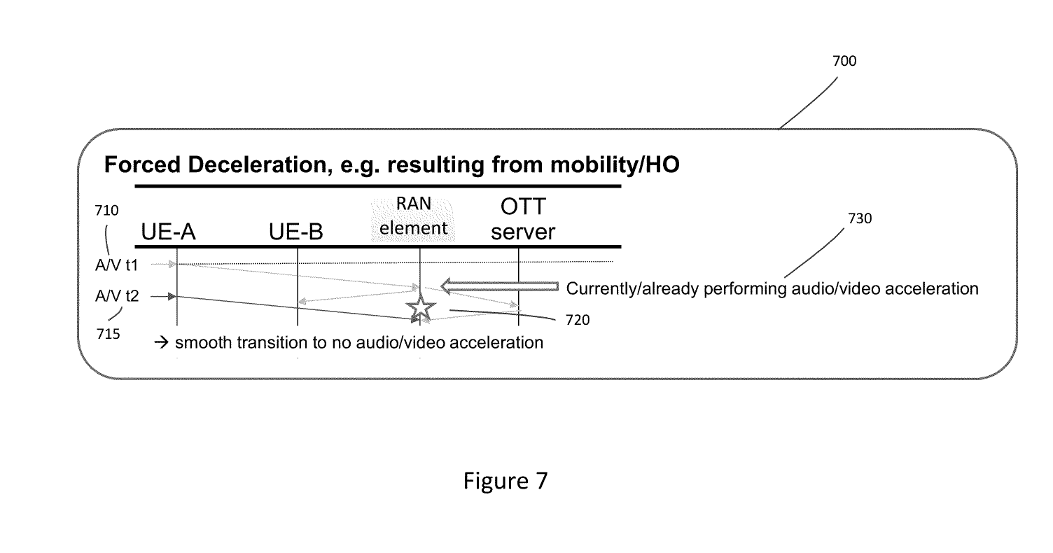

FIG. 7 illustrates a forced deceleration method 700 according to certain embodiments. In this method there may be a smooth transition to no audio/video acceleration. For instance, at 720, the eNB/RAN element 117 may determine that, because of a handoff, the eNB/RAN element 117 needs to stop performing audio/video acceleration. This stop may, for example, be determined to begin 80 milliseconds from a determined time.

Consequently, eNB/RAN element 117 may achieve a smooth transition from audio/video acceleration 730 to no audio/video acceleration by various techniques. For example, the eNB/RAN element 117 may stretch out audio/video content 710, 715 to be delivered to UE-B 114, such that UE-B's playout will take, for example, 80 milliseconds to playout 60 milliseconds worth of audio. Thereafter, the eNB/RAN element 117 may return to normal operation. In another option, the eNB/RAN element 117 may cause the audio/video Quality of Service (QOS) used by the telephony call for the rest of the currently ongoing talkspurt to have a shorter delay requirement. This may, for example, enable maintaining the overall QOS or audio requirement for the rest of that talkspurt, even though a copy/paste technique is not being used to reduce the over the air delay for the rest of that talkspurt. Prior to a subsequent talkspurt, an additional silent interval can be inserted, such that the subsequent talkspurt can have a normal/longer QOS delay budget.

In the copy/paste technique two different things may occur. For example, the media content from t1, UE-A 112, goes up and hits the eNB/Radio Access Network Edge Optimizer Module (RAN) element 117 and is immediately copied off of what is received from the uplink from UE-A 112. Then the media content is pasted into the packet which originally contained a silent audio containing packet that was going down to UE-B 114 but instead of sending down silence, a copy of the uplinked media from UE-A 112 is sent down to UE-B 114. Therefore, the content received from UE-A 112 on the uplink is copied into a packet or another packet that already exists but the packet did not contain any content except for silence because UE-A 112 was silent just before starting to talk. This copied audio information goes into the packet which is downlinked to UE-B 114 and therefore UE-B 114 will get the content faster. Then in parallel this audio packet that was just copy/pasted from UE-A 112 is sent up to OTT server 119. Furthermore, this audio packet is monitored and say 20 milliseconds later that same audio packet from UE-A 112 that was sent up to OTT server 119 comes back down from OTT server 119 and the packet may be sent back down to UE-B 114. At that point the packet checked to see if it is the packet that was already sent to UE-B 114 via the copy/paste technique and if the answer is yes then everything is good and the copy/paste technique just sent the content faster with no problems to UE-B 114.

Alternatively, for example, content may be copied off of the uplink, and pasted into packets for delivery on the downlink, where content may be replaced in the downlink packets which may be non-silent, but which has already been previously delivered by virtue of earlier usage of the copy/paste technique.

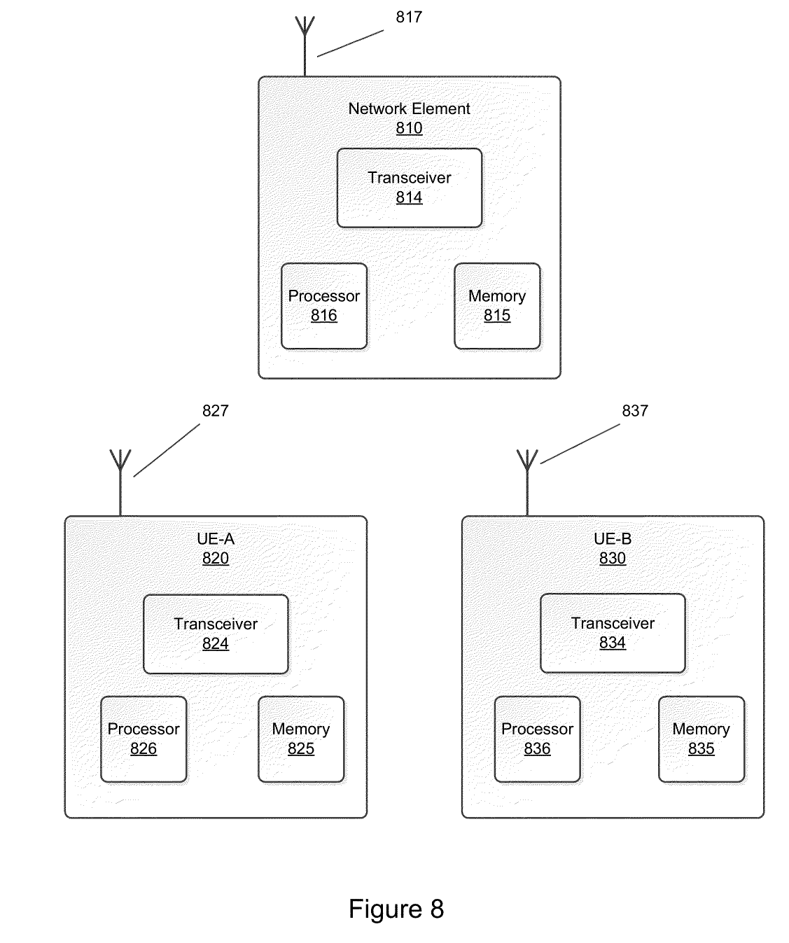

FIG. 8 illustrates a system according to certain embodiments of the invention. In one embodiment, a system may comprise several devices, such as, for example, a network element 810, a first user equipment (UE-A) 820, and a second user equipment (UE-B) 830. Network element 810 may correspond to eNB/RAN element 117, shown in FIGS. 1-7. The system may comprise more than two user equipment, although only two user equipment are shown for the purposes of illustration. The first user equipment (UE-A) 820 may be a mobile telephone system and/or Voice over IP (VoIP) system. Alternatively, first user equipment (UE-A) 820 may be a mobile phone, personal digital assistant (PDA), e-reader, sensor, smart meter, peripheral or any communications device. The first user equipment (UE-A) 820 and/or the second user equipment (UE-B) 830 may likewise be a mobile phone, PDA, e-reader, sensor, smart meter, peripheral or any communications device. Network element 810 may have a modular architectures in which incrementally heavier duty application code may be running closer to or co-located with the radio access network or the evolved Node B (eNB). For example, in cell phone towers there may be application code running in the cell tower. The code running may be re-compressing voice/audio when transcoding at the cell tower. For instance, if a user is speaking Japanese on the uplink, code can do real-time zero delay translation at the cell tower to send English on the downlink to another user.

Each of the devices in the system may comprise at least one processor, respectively indicated as 816, 826 and 836. At least one memory may be provided in each device, and indicated as 815, 825 and 835, respectively. The memory may comprise computer program instructions or computer code contained therein. One or more transceiver 814, 824 and 834 may be provided, and each device may also comprise an antenna, respectively illustrated as 817, 827 and 837. Although only one antenna each is shown, many antennas and multiple antenna elements may be provided to each of the devices. Other configurations of these devices, for example, may be provided. For example, network element 810, first user equipment (UE-A) 820 and second user equipment (UE-B) 830 may be additionally or solely configured for wired communication, and in such a case antennas 817, 827 and 837 may illustrate any form of communication hardware, without being limited to merely an antenna.

Transceivers 814, 824 and 834 may each, independently, be a transmitter, a receiver, or both a transmitter and a receiver, or a unit or device that may be configured both for transmission and reception.

Processors 816, 826 and 836 may be embodied by any computational or data processing device, such as a central processing unit (CPU), application specific integrated circuit (ASIC), or comparable device. The processors may be implemented as a single controller, or a plurality of controllers or processors.

Memories 815, 825 and 835 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors may be any suitable form of computer program code, for example, a compiled or interpreted computer program written in any suitable programming language.

The memory and the computer program instructions may be configured, with the processor for the particular device, to cause a hardware apparatus such as network element 810, first user equipment (UE-A) 820 and second user equipment (UE-B) 830, to perform any of the processes described above (see, for example, FIGS. 2, 4, 6, 7, 9 and 10). Therefore, in certain embodiments, a non-transitory computer-readable medium may be encoded with computer instructions that, when executed in hardware, may perform a process such as one of the processes described herein. Alternatively, certain embodiments of the invention may be performed entirely in hardware.

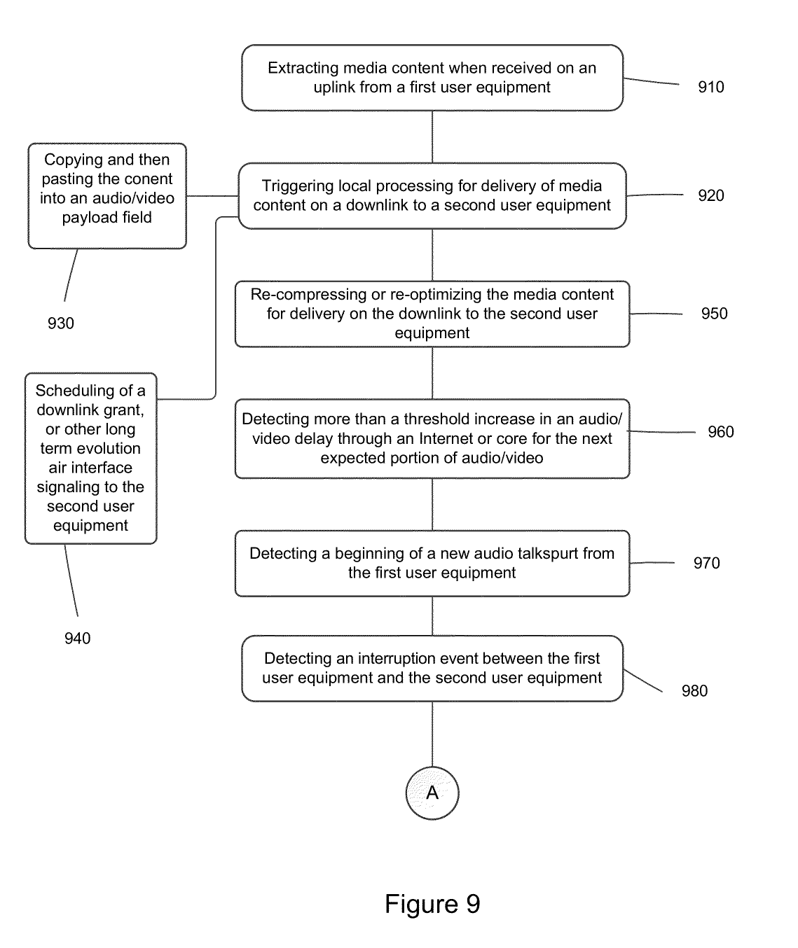

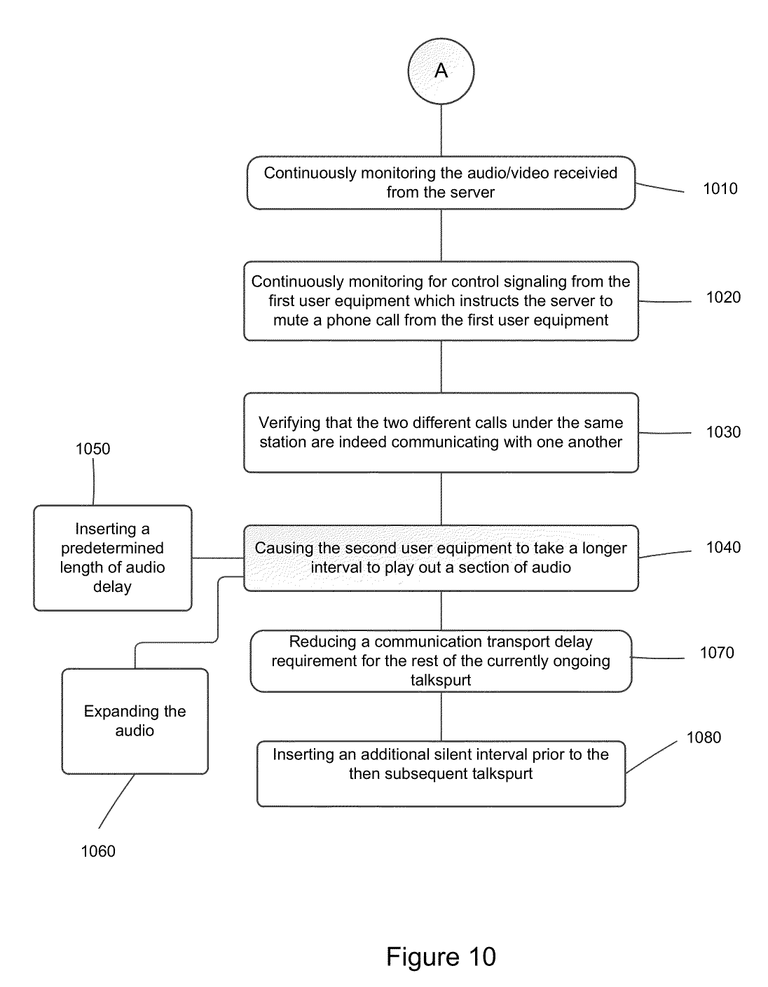

FIGS. 9 and 10 illustrate a flowchart according to certain embodiments of the invention. As shown in FIG. 9, a method may comprise, at 910, extracting an audio/video/media content when received on an uplink from a first user equipment.

The method may also comprise, at 920, triggering local processing (for example, eNB/RAN element) for delivery of audio/video/media content to a downlink to a second user equipment.

The method may also comprise, at 930 which branches from 920, copying and then pasting the content into an audio/video payload field being received from an Internet or core network for delivery to the second user equipment under a same radio access network edge optimizer module/midpoint.

The method may also comprise, at 940 which branches form 920, scheduling of a downlink grant, or other long term evolution air interface signaling to the second user equipment to prepare for delivery of observed content received from the first user equipment.

The method may also comprise, at 950, re-compressing or re-optimizing the audio/video signal in parallel from the server on the downlink to the second user equipment. For example, when the re-compressed or re-optimized media content for delivery on the downlink is performed in parallel with waiting for an evolved packet core to server round trip time.

The method may also comprise, at 960, detecting more than a threshold increase in an audio/video delay through an Internet or core network for the next expected portion of audio/video.

The method may also comprise, at 970, detecting a beginning of a new audio talkspurt from the first user equipment.

The method may also comprise, at 980, detecting an interruption event between the first user equipment and the second user equipment. For example, detecting a new talkspurt from the first user equipment and the second user equipment, during a first most recent time interval.

As shown in FIG. 10, the method may comprise, at 1010, continuously monitoring the audio/video received from the server, to verify that the server is continuing to forward the audio/video from the first user equipment to the second user equipment.

The method may also comprise, at 1020, continuously monitoring for control signaling from the first user equipment which instructs the server to mute a phone call from the first user equipment.

The method may also comprise, at 1030, verifying that the two different calls under the same base station are indeed communicating with one another by using a unique background audio/video signature.

The method may also comprise, at 1040, causing the second user equipment to take a longer interval to play out a section of audio.

The method may also comprise, at 1050 and 1060 which branch from 1040, respectively, inserting a predetermined length of audio delay and expanding the audio.

The method may also comprise, at 1070, reducing a communication transport delay requirement for the rest of the currently ongoing talkspurt.

The method may also comprise, at 1080, inserting an additional silent interval prior to the then subsequent talkspurt, wherein the then subsequent talkspurt has a normal or longer quality of service delay.

The above discussed embodiments may, for example, enable the eNB/RAN element 117 to play a value-added role for mobile-to-mobile communications. In some embodiments wireless aware re-compression/optimization of voice/video may be enabled without any additional re-compression delays/strict delay requirement. The audio/video/media content may be extracted when it is received on the uplink from the first mobile, may then be re-compressed/customized for delivery on the downlink to the second mobile. When the original content is received back from the server for delivery to the second mobile, at that point the already re-compressed/customized version of the content may be transmitted down to the second mobile.

In other embodiments, delays associated with scheduling of downlink grant, or other LTE air interface signaling to second user can be leveraged to prepare for delivery of content received from a first user, thereby avoiding latency associated with UE DRX are avoided.

In some embodiments, delays up through the EPC onto the general Internet and back may be bypassed. This feature may, for example, mitigate sporadic jitter through the EPC-Server path, may provide an ongoing audio/video delay reduction with smooth transition into/out of this reduction mode, and/or may minimize audio overlap in telephony interruption scenarios.

In some embodiments audio degradation may be avoided resulting from audio packet jitter over the Internet. This may be particularly beneficial for, for example, an OTT voice/video telephony solution. Some embodiments may provide the ability to reduce the audio delay in telephony calls on a sustained basis, along with smooth audio acceleration/deceleration. Moreover, certain embodiments may reduce audio interruption scenarios and minimize the audio overlap in telephony interruption.

One having ordinary skill in the art will readily understand that the invention as discussed above may be practiced with steps in a different order, and/or with hardware elements in configurations which are different than those which are disclosed. Therefore, although the invention has been described based upon these embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

I claim:

1. A method, comprising:
extracting an audio/video/media content when received on an uplink from a first user equipment; and
triggering local processing for delivery of the audio/video/media content on a downlink to a second user equipment,
wherein the local processing for delivery of the audio/video/media content on the downlink to the second user equipment is performed during an original audio/video/media content round trip to and from a server.

2. The method of claim 1, wherein the local processing comprises:
re-compressing or re-optimizing of the audio/video/media content during the original audio/video/media content round trip to and from the server.

3. The method of claim 1, wherein the triggered local processing further comprises:
copying and then pasting the content into an audio/video payload field being received from an Internet or core network for delivery to the second user equipment under a same radio access network edge optimizer module/midpoint prior to the original audio/video/media content round trip to and from the server.

4. The method of claim 3, wherein the re-compressing or re-optimizing content for delivery further comprises:
enabling usage of cloud-based resources for content optimization through an internet offload gateway.

5. The method of claim 1, wherein the triggered local processing further comprises:
scheduling of a downlink grant, or other long term evolution air interface signaling to the second user equipment to prepare for delivery of observed content received from the first user equipment.

6. The method of claim 5, wherein the scheduling of a downlink grant, or other long term evolution air interface signaling to the second user equipment to prepare for delivery of observed content received from the first user equipment is performed in parallel with waiting for an evolved packet core to server round trip time.

7. The method of claim 5, wherein the scheduling of a downlink grant, or other long term evolution air interface signaling to the second user equipment to prepare for delivery of observed content received from the first user equipment is performed such that the signaling completes just-in-time for the content arrival from the server at the completion of the evolved packet core to server round trip time.

8. The method of claim 5, wherein the size of the downlink grant to the second user equipment is established based on the content received on the uplink from the first user equipment.

9. The method of claim 8, wherein when the content is received from the server for transmission on the downlink an uplink grant has already been scheduled prior to the packet arriving at a base station.

10. The method of claim 1, further comprising:
detecting more than a threshold increase in an audio/video delay through an Internet or core for the next expected portion of audio/video.

11. The method of claim 1, further comprising:
detecting a beginning of a new audio talkspurt from the first user equipment.

12. The method of claim 1, further comprising:
detecting an interruption event between the first user equipment and the second user equipment,
wherein detecting the interruption event comprises detecting a new talkspurt from the first user equipment and the second user equipment, during a first most recent time interval.

13. The method of claim 1, further comprising:
continuously monitoring the audio/video received from the server, to verify that the server is continuing to forward the audio/video from the first user equipment to the second user equipment.

14. The method of claim 1, further comprising:
continuously monitoring for control signaling from the first user equipment which instructs the server to mute a phone call from the first user equipment.

15. The method of claim 13, wherein if a network element detects that the server is no longer forwarding the audio/video from the first user, then the network element initiates transition to no longer transferring the audio/video from the first user equipment uplink to the packet is transmitted to the second user equipment on the downlink

16. The method of claim 1, further comprising:
verifying that the two different calls under the same base station are indeed communicating with one another by using a unique background audio/video signature.

17. The method of claim 1 wherein, upon detection of the need to stop local processing
causing the second user equipment to take a longer interval to play out a section of audio.

18. The method of claim 17, wherein providing the longer interval comprises
inserting a predetermined length of audio delay.

19. The method of claim 17, wherein providing the longer interval comprises
expanding the audio.

20. The method of claim 1 wherein, upon detection of the need to stop local processing,
reducing a communication transport delay requirement for the rest of the currently ongoing talkspurt.

21. The method of claim 20, further comprising:
inserting an additional silent interval prior to the then subsequent talkspurt, wherein the then subsequent talkspurt has a normal or longer quality of service delay.

22. An apparatus, comprising:
at least one processor; and
at least one memory including computer program code,
wherein the at least one memory and the computer program code are configured to, with the at least one processor, cause the apparatus at least to
extract an audio/video/media content when received on an uplink from a first user equipment; and
trigger local processing for delivery of the audio/video/media content on a downlink to a second user equipment,
wherein the local processing for delivery of the audio/video/media content on the downlink to the second user equipment is performed during an original audio/video/media content round trip to and from a server.

23. The apparatus of claim 22, wherein the at least one memory and the computer program code are configured to, with the at least one processor, cause the apparatus at least to, as the triggered local processing, re-compress or re-optimize the audio/video/media content during the original audio/video/media content round trip to and from the server.

24. The apparatus of claim 22, wherein the at least one memory and the computer program code are configured to, with the at least one processor, cause the apparatus at least to, as the triggered local processing, copy and then paste the content into an audio/video payload field being received from an Internet or core network for delivery to the second user equipment under a same radio access network edge optimizer module/midpoint prior to the original audio/video/media content round trip to and from the server.

25. The apparatus of claim 24, wherein the at least one memory and the computer program code are configured to, with the at least one processor, cause the apparatus at least to, when re-compressing or re-optimizing content for delivery, enable usage of cloud-based resources for performing mobile internet protocols through an internet offload gateway.

26. The apparatus of claim 22, wherein the at least one memory and the computer program code are configured to, with the at least one processor, cause the apparatus at least to, as the triggered local processing, schedule a downlink grant, or other long term evolution air interface signaling, to the second user equipment to prepare for delivery of observed content received from the first user equipment.

27. The apparatus of claim 26, wherein the scheduling of a downlink grant, or other long term evolution air interface signaling to the second user equipment to prepare for delivery of observed content received from the first user equipment is performed in parallel with waiting for an evolved packet core to server round trip time.

28. The apparatus of claim 26, wherein the scheduling of a downlink grant, or other long term evolution air interface signaling to the second user equipment to prepare for delivery of observed content received from the first user equipment is performed such that the signaling completes just-in-time for the content arrival from the server at the completion of the evolved packet core to server round trip time.

29. The apparatus of claim 26, wherein the size of the downlink grant to the second user equipment is established based on the content received on the uplink from the first user equipment.

30. The apparatus of claim 29, wherein when the content is received from the server for transmission on the downlink an uplink grant has already been scheduled prior to the packet arriving at a base station.

31. The apparatus of claim 22, wherein the at least one memory and the computer program code are configured to, with the at least one processor, cause the apparatus at least to detect more than a threshold increase in an audio/video delay through an Internet or core network for the next expected portion of audio/video.

32. The apparatus of claim 22, wherein the at least one memory and the computer program code are configured to, with the at least one processor, cause the apparatus at least to detect a beginning of a new audio talkspurt from the first user equipment.

33. The apparatus of claim 22, wherein the at least one memory and the computer program code are configured to, with the at least one processor, cause the apparatus at least to detect an interruption event between the first user equipment and the second user equipment,
wherein the detection of the interruption event comprises detecting a new talkspurt from the first user equipment and the second user equipment, during a first most recent time interval.

34. The apparatus of claim 22, wherein the at least one memory and the computer program code are configured to, with the at least one processor, cause the apparatus at least to continuously monitor the audio/video received from the server, to verify that the server is continuing to forward the audio/video from the first user equipment to the second user equipment.

35. The apparatus of claim 22, wherein the at least one memory and the computer program code are configured to, with the at least one processor, cause the apparatus at least to continuously monitor for control signaling from the first user equipment which instructs the server to mute a phone call from the first user equipment.

36. The apparatus of claim 34, wherein if the apparatus detects that the server is no longer forwarding the audio/video from the first user, then the network element initiates transition to no longer transferring the audio/video from the first user equipment uplink to the packet is transmitted to the second user equipment on the downlink

37. The apparatus of claim 22, wherein the at least one memory and the computer program code are configured to, with the at least one processor, cause the apparatus at least to verify that the two different calls under the same base station are indeed communicating with one another by using a unique background audio/video signature.

38. The apparatus of claim 22 wherein, upon detection of the need to stop local processing, the at least one memory and the computer program code are configured to, with the at least one processor, cause the apparatus at least to cause the second user equipment to take a longer interval to play out a section of audio.

39. The apparatus of claim 38, the at least one memory and the computer program code are configured to, with the at least one processor, cause the apparatus at least to in providing the longer interval, insert a predetermined length of audio delay.

40. The apparatus of claim 38, the at least one memory and the computer program code are configured to, with the at least one processor, cause the apparatus at least to, in providing the longer interval, expand the audio.

41. The apparatus of claim 22, wherein, upon detection of the need to stop local processing, the at least one memory and the computer program code are configured to, with the at least one processor, cause the apparatus at least to reduce a communication transport delay requirement for the rest of the currently ongoing talkspurt.

42. The apparatus of claim 41, wherein the at least one memory and the computer program code are configured to, with the at least one processor, cause the apparatus at least to insert an additional silent interval prior to the then subsequent talkspurt, such that the then subsequent talkspurt has a normal or longer quality of service delay.
